(19) United States
(12) Patent Application Publication
(10) Pub. No.: US 2021/0095095 A1
(43) Pub. Date: Apr. 1, 2021

(54) LIGHT EMITTING ELEMENT

(71) Applicants: Röhm GmbH, Darmstadt (DE); Roehm America LLC, Parsippany, NJ (US)

(72) Inventors: René Kogler, Pfofeld (DE); Rüdiger Carloff, Darmstadt (DE); Christopher Walby, New Albany, OH (US)

(73) Assignees: Röhm GmbH, Darmstadt (DE); Roehm America LLC, Parsippany, NJ (US)

(21) Appl. No.: 15/733,404

(22) PCT Filed: Jan. 22, 2019
(86) PCT No.: PCT/EP2019/051426

§ 371 Date: Jul. 22, 2020

Related U.S. Application Data
(60) Provisional application No. 62/621,294, filed on Jan. 24, 2018.

(30) Foreign Application Priority Data
Feb. 7, 2018 (EP) 18155518.6

(51) Int. Cl. C08K 5/3475; F21V 8/00; C08K 5/20

(52) U.S. Cl. CPC C08K 5/3475; G02B 6/0065; C08K 5/20; G02B 6/0043; G02B 6/0041

(57) ABSTRACT

A light emitting element includes edge-lit luminaires of transparent light guiding material having an increased resistance against UV-light and high temperatures. The light emitting element can be advantageously employed as a light source in outdoor applications such as traffic signs, street lights, advertising panels, outdoor illumination means or in exterior vehicle lighting.

### FIELD OF THE INVENTION

The present invention relates to a light emitting element comprising edge-lit luminaires of transparent light guiding material having an increased resistance against UV-light and high temperatures. The element can be advantageously employed in applications in which the light emitting element is exposed to weathering, solar radiation and increased temperatures resulting from use of high power light sources, outdoor temperatures and/or direct sunlight, e.g. in outdoor applications.

### BACKGROUND OF THE INVENTION

In a common edge-lit unit, a light source emits light into a light guide unit, which redirects and scatters the light. The light guide unit is usually formed of a transparent material and has at least one edge located in a close proximity to the light source to enable in-coupling of light. Among different light sources for an edge-lit unit light emitting diodes (LEDs) are particularly preferred due to their high efficiency, cold-cathode fluorescent lamps (CCFLs) being a further common choice.

A light guide unit may comprise light scattering components or structures which are either located in the bulk of the material or on at least one surface of the light guide unit and allow scattering of the light at angles smaller than the total reflection angle. This allows emission of light from at least one surface of the light guide unit.

Light scattering components in the light guide unit can include e.g. organic or inorganic scattering beads (cf. EP 1 453 900 A1, EP 2 556 395 A1) or other components having a refractive index different from the transparent material of the light guide unit.

Surface structuring of the light guide unit is achievable through various methods and depends on the manufacturing process of the light guide. For injection (compression) moulded parts, structuring possibilities include use of a structured mould, laser structuring and printing. Extruded light guide units can be structured in-line by various methods such as engraving, use of structured rolls (WO 2012/101205 A1), laser engraving (WO 2013/026834 A1), or off-line through e.g. lamination (WO 2011/000636 A1), flatbed screen printing, mechanical processing, embossing of a thermally or UV-light curable lacquer, laser, hot embossing and printing.

For instance, WO 2015/010871 A1 describes a light guide plate comprising a colourless transparent sheet and an opaque white or translucent white thermoplastic reflector film, wherein an optical connection between the colourless transparent sheet and the reflector film is provided by

(i) a colourless thermoplastic applied by structured printing and having a glass transition temperature above 25° C. and below glass transition temperatures of a material of the colourless transparent sheet and of the thermoplastic of the reflector film, or by

(ii) a reactive adhesive with an activation temperature between 25° C. and the glass transition temperature of the material of the colourless transparent sheet and of the thermoplastic of the reflector film, and wherein there is no direct optical contact between the colourless transparent sheet and the reflector film.

Edge-lit units have been used in electronics industry applications for display illumination, e.g. in flat-screen TVs, cell phones, notebooks, E-book readers, for the signage and lighting industry and for automotive lighting. These products commonly employ poly(methyl)methacrylate (PMMA) as material of the light guide unit because of its advantageous light guiding properties. As an alternative to PMMA, poly(methyl)methacrylimide (PMMI) is sometimes used for applications in which a particularly high resistance to increased temperatures is important. Inorganic glass is another commonly used light guide material. In some cases, polycarbonates, polystyrenes and copolymers of styrene and methyl methacrylate are also employed as light guide unit materials.

### Technical Problems of the Prior Art

A well-known drawback of many transparent organic polymeric materials is their limited stability under conditions, where these materials are consistently exposed to conditions such as increased humidity, elevated temperature, temperature and humidity cycles, and direct solar radiation. Amongst manifold degradation mechanisms, undesired material yellowing i.e. colour change accompanied by transmittance deterioration, is the most relevant one. This yellowing results from formation of coloured species in the light guide unit material.

Furthermore, when a transparent organic polymeric material is exposed to solar radiation, its transmittance is lowered concomitant with the colour change and a gradient of colour change is commonly observed. This results in an aesthetically disadvantageous appearance of the transparent organic polymeric material to the viewer. For certain applications, e.g. in the automotive industry or in signage, this also becomes a safety issue.

Typical applications of light emitting elements based on the edge-lit technology and comprising a light guide unit of a polymeric material are indoor applications such as office lighting or a display backlight. Light emitting elements in electronic devices are typically protected with additional UV-absorbing layers or sheets and are usually not exposed to outdoor conditions and UV light.

Although neat PMMA and PMMI have a relatively high inherent stability against solar radiation, their long-term outdoor use, nevertheless, requires an additional UV protection. For instance, benzotriazole-type UV absorbers, such as Tinuvin® P, available from BASF SE, are commonly used for this purpose.

UV absorbers are typically added to polymeric materials in concentrations of up to 0.5 wt.-% and render them to exhibit a strong absorption between 300 nm and 400 nm. However, attempts to use conventional UV absorbers in light guide units lead to several technical problems:

The light emitted by a light source enters the edge of a light guide unit and passes a long light path in the light guide unit material, before exiting the light guide unit from one of its light emitting surfaces. As a result of this long light path, the absorption edge of the UV absorber can be shifted from the UV region into the visible blue region. Due to absorption of visible blue light of the light source by the guide unit material, the light emitted from the surface of the light guide unit appears yellow, even if the light source located on the edge of the light guide unit emits white light.

Furthermore, the degree of yellowness of the emitted light increases with the increasing distance from the light source, which is particularly inacceptable for aesthetic reasons. For instance, when a white light emitting diode (LED) such as GaN- or InGaN-LED is used as a light source, a significant portion of blue light becomes “lost” within the light guide unit. This results in a progressive yellowing of the light emitted from the surface of the light guide unit. An attempt to overcome this problem by reducing the concentration of the UV absorber usually strongly reduces stability of the material against UV radiation, in particular solar radiation, and renders it unsuitable for an outdoor use.

Another problem arises from the fact that common UV absorbers, when exposed to solar radiation for longer time, can generate coloured decomposition species. These species cause additional yellowing of the polymeric light guide, which, in turn, results in an uneven yellow appearance. Again, since the light emitted from a light source passes a long light path in the light guide unit material, even a low concentration of decomposition species leads to a significant absorption of the blue light. Accordingly, the light emitted from the surface of the light guide unit appears yellow.

Finally, when a high power LED is used as a light source, thermal stability of the light guide unit material becomes increasingly important. The efficiency of a typical white LED ranges from 5 to 40%, which means that about 60 to 95% of the consumed electricity is dissipated as heat. As a result of a compact design of a high-power white LED, the operating temperature on its surface may reach 100° C. or even higher. In particular, if the high-power LED is in a direct contact with the edge of the light guide unit, the light guide unit material needs to have a sufficient thermal stability.

US 2015/148508 A1 describes a (meth)acrylic resin composition which may optionally comprise an UV absorber such as 2-ethyl-2′-ethoxy-oxalic anilide (manufactured by Clariant (Japan) K.K., trade name: Sanduvor® VSU). The document does not teach a light emitting element for outdoor use which comprises edge-lit luminaires of transparent light guiding material with Sanduvor® VSU.

JP 2002-265738 A also discloses a methyl methacrylate resin composition characterized by containing 0.0005 to 0.1 part by weight of oxalanilide based on 100 parts by weight of methyl methacrylate resin.

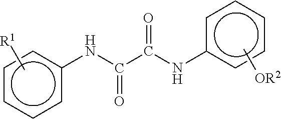

wherein in the formula, R¹ and R² each independently represent an alkyl group having 1 to 6 carbon atoms. The document does not teach a light emitting element for outdoor use.

### Object of the Present Invention

Upon consideration of the above described technical problems, it was an object of the present invention to provide a light guide unit which is suitable for a long-term use upon exposure to UV light and/or increased temperatures and has an excellent weathering resistance, in particular, high stability against solar radiation. Nevertheless, said light guide unit should not suffer from a significant absorption of the blue light portion of the light emitted by a light source arranged on its edge. Furthermore, said light guide unit needs to have a particularly low increase of the yellowness index under typical outdoor conditions. Furthermore, the light guide unit needs to have a sufficient thermal stability to allow its use with light sources having high operating temperatures on their surface, e.g. high power white LEDs.

A further object addressed by the present invention was provision of a light emitting element based on edge-lit technology suitable for a long-term outdoor use, even in areas having high solar radiation and increased temperatures. Such light emitting element needs to emit strong aesthetically appealing white light.

Yet a further object of the present invention was provision of a light emitting device comprising a light emitting element as specified above.

### SUMMARY OF THE INVENTION

The present invention is based on a surprising finding that a moulding composition comprising a light transmitting polymeric material such as PMMA or PMMI in combination with a compound of Formula (I)

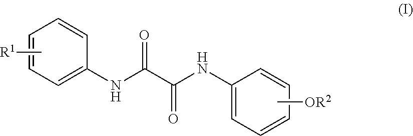

in which the moieties R¹ and R² are independently an alkyl or cycloalkyl moiety having from 1 to 10 carbon atoms
not only has an excellent stability against UV radiation, e.g. solar radiation and/or increased operating temperatures but also have a low absorption of visible blue light at longer light paths. Therefore, if a light guide unit composed of such material is used in combination with a white light source, the light emitted from a surface of the light guide unit has an aesthetically pleasing white appearance. Nevertheless, the material of the light guide unit has an excellent long-term outdoor stability and shows substantially no signs of yellowing, even after a long-time outdoor use.

Additionally, the corresponding moulding composition has a surprisingly high thermal stability, even in the absence of thermal stabilisers, and can therefore be used in combination with light sources such as high-power LEDs.

Accordingly, in one aspect of the present invention, a light emitting element for outdoor use is provided. The light emitting element comprises a light guide unit having at least one edge and at least one surface and at least one light source arranged on the at least one edge of the light guide unit.

The light emitting element of the present invention is characterised in that the at least one surface of the light guide unit is directly exposed to the outdoor environment and the light guide unit comprises a moulding composition comprising:

a) a substantially light transmitting polymeric material; and

b) at least one compound of Formula (I)

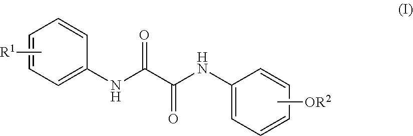

in which the moieties R¹ and R² are independently an alkyl or cycloalkyl moiety having from 1 to 10 carbon atoms.

A further aspect of the present invention is an edge-illuminated light emitting device for outdoor use and use at increased temperatures comprising the above light emitting element. The present invention further relates to use of the light emitting element for the manufacturing of an outdoor light emitting device. In other words, the present invention allows use of the light emitting element for the manufacturing of an outdoor light emitting device.

Finally, the present invention relates to use of said outdoor light emitting device as a light source for backlighting in traffic signs, street lights, advertising panels, outdoor illumination means or in exterior vehicle lighting.

### BRIEF DESCRIPTION OF THE DRAWINGS

FIG. 1a Example of a light emitting element with scattering particles according to the present invention
1 light guide unit
2 surface of the light guide unit 1 exposed to the environment
3 edge of the light guide unit 1
4 a light source (LED) arranged on the edge 3 of the light guide unit 1
5 scattering particles

FIG. 1b Example of a light emitting element according to the present invention with a scattering layer 6

FIG. 2 Transmittance of a 3.2 mm sample comprising 100 ppm Tinuvin® P (Sample 1) and a 3.9 mm PMMA sample comprising 800 ppm Tinuvin® 312 (Sample 2)

FIG. 3 Transmittance of 145 mm PMMA samples comprising 100 ppm Tinuvin® P (Sample 3) and 800 ppm Tinuvin® 312 (Sample 4)

FIG. 4a Evolution of the yellowness index (Y.I.) of PMMA samples comprising 100 ppm Tinuvin® P (Samples 1 and 5) and 800 ppm Tinuvin® 312 (Sample 2) during the accelerated laboratory weathering test “Arizona”

FIG. 4b Evolution of the yellowness index (Y.I.) of PMMA samples comprising 100 ppm Tinuvin® P (Samples 1 and 5) and 800 ppm Tinuvin® 312 (Sample 2) during the accelerated laboratory weathering test “Florida”

FIG. 5a Evolution of Haze of PMMA samples comprising 100 ppm Tinuvin® P (Samples 1 and 5) and 800 ppm Tinuvin® 312 (Sample 2) during the accelerated laboratory weathering test “Arizona”

FIG. 5b Evolution of Haze of PMMA samples comprising 100 ppm Tinuvin® P (Samples 1 and 5) and 800 ppm Tinuvin® 312 (Sample 2) during the accelerated laboratory weathering test “Florida”

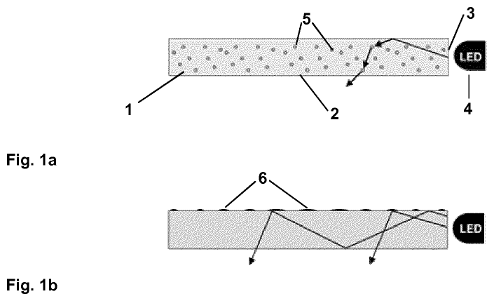

### DETAILED DESCRIPTION OF PREFERRED EMBODIMENTS

The expression “light emitting element” as used herein refers to a device comprising at least a light guide unit and a light source. The light guide unit has at least one edge and at least one surface and typically has a form of a sheet. The light guide unit can be produced e.g. by extrusion or by a continuous casting process (continuous cast) or by injection (compression) moulding.

The shape of the light guide unit is not particularly limited. For instance, the light guide unit may be substantially flat i.e. planar or may be of a more complex geometrical object. Accordingly the maximal optical path length of the light guide unit may vary depending on the desired application. Typically, the maximal optical path length of the light guide unit ranges from about 50 mm to 2 000 mm, more preferred from 70 mm to 1 000 mm, even more preferred from 100 mm to 800 mm.

According to the present invention, the light emitting element comprises at least one light source arranged on at least one edge of the light guide unit. The choice of the light source is not particularly limited, as long as the maximal operating temperature on the surface of the light source is compatible in terms of heat resistance with the moulding composition. For instance, light emitting diodes (LEDs), cold-cathode fluorescent lamps (CCFLs), neon lamps, mercury-vapour lamps or high-pressure sodium lamps can be employed. Typically, the light source is selected from LEDs and CCFLs, LEDs being particularly preferred.

As used herein, the term “substantially light transmitting polymeric material” refers to a material having a transmittance (D₆₅) of at least 50%, preferably at least 60%, more preferably at least 70%, even more preferably at least 80% and particularly preferably at least 90%, determined on a sample with a thickness of 3.2 mm according to the norm ISO 13468-2.

The light emitting element may optionally comprise a reflective film attached to a surface of the light guide unit opposite to the surface facing the environment, as described in the patent application WO 2015/010871 A1, the entire disclosure of which is incorporated herein by reference. In this embodiment, substantially the entire light emitted by the light source exits the light emitting element from the surface exposed to the outdoor environment. Hence, such light emitting element has a particularly high efficiency.

In further embodiment, the light guide unit may comprise a substantially opaque reflector film, an adhesive layer, which comprises an adhesive material, and a transparent sheet, wherein the transparent sheet and the reflector film are bonded together by the adhesive layer which is located between the transparent sheet and the reflector film and the adhesive layer provides an optical connection between the transparent sheet and the reflector film, the light guide plate. Preferably, the adhesive layer forms a pattern comprising a plurality of closed cavities. Such light guide units are described in the patent application EP 3147561, the entire disclosure of which is incorporated herein by reference.

The light guide unit in the light emitting element is composed of a moulding composition comprising a substantially light transmitting polymeric material and a compound of Formula (I). The substantially light transmitting polymeric material may be selected from polyalkyl(meth)acrylate, poly(meth)acrylmethylimide, polycarbonate, polystyrene, polyethylene terephthalate, polyethylene, polypropylene, a styrene-copolymer, a cycloolefin, a cycloolefin-copolymer or a mixture thereof. In particularly preferred embodiments, the substantially light transmitting polymeric material is selected from polyalkyl(meth)acrylate, poly(meth)acrylalkylimide or a mixture thereof.

The polyalkyl(meth)acrylate can be used alone or as a mixture of different polyalkyl (meth)acrylates. The polyalkyl(meth)acrylate can moreover also be a copolymer. The term “(meth)acrylate” as used herein refers not only to methacrylates, e.g. methyl methacrylate, ethyl methacrylate, etc., but also acrylates, e.g. methyl acrylate, ethyl acrylate, etc. and also to mixtures composed of these repeating units.

For the purposes of the present invention, particular preference is given to homo- and copolymers of C₁-C₁₈-alkyl (meth)acrylates, advantageously of C₁-C₁₀-alkyl (meth)acrylates, in particular of C₁-C₄-alkyl (meth)acrylate polymers, and these can, if appropriate, also comprise repeating units which differ therefrom.

It has proved particularly advantageous to use copolymers which contain from 70 wt.-% to 99.5 wt.-%, in particular from 80 wt.-% to 99.5 wt.-%, of C₁-C₁₀-alkyl (meth)acrylates, based on the weight of the copolymer. Preferred C₁-C₁₀-alkyl methacrylates encompass methyl methacrylate, ethyl methacrylate, propyl methacrylate, isopropyl methacrylate, n-butyl methacrylate, isobutyl methacrylate, tert-butyl methacrylate, pentyl methacrylate, hexyl methacrylate, heptyl methacrylate, octyl methacrylate, isooctyl methacrylate, and ethylhexyl methacrylate, nonyl methacrylate, decyl methacrylate, and also cycloalkyl methacrylates, for example cyclohexyl methacrylate, isobornyl methacrylate or ethylcyclohexyl methacrylate. Use of methyl methacrylate is particularly preferred.

Preferred C₁-C₁₀-alkylacrylates encompass methyl acrylate, ethyl acrylate, propyl acrylate, isopropyl acrylate, n-butyl acrylate, isobutyl acrylate, tert-butyl acrylate, pentyl acrylate, hexyl acrylate, heptyl acrylate, octyl acrylate, isooctyl acrylate, nonyl acrylate, decyl acrylate, and ethylhexyl acrylate, and also cycloalkyl acrylates, for example cyclohexyl acrylate, isobornyl acrylate or ethylcyclohexyl acrylate.

Very particularly preferred copolymers encompass from 90 wt.-% to 99.8 wt.-% of methyl methacrylate (MMA) units and from 0.2 wt.-% to 10 wt.-%, preferably from 0.5 wt.-% to 2.0 wt.-% of C₁-C₁₀-alkyl acrylate units, in particular methyl acrylate units, ethyl acrylate units and/or butyl acrylate units, based on the weight of the copolymer. The corresponding copolymers are commercially available under the trademark PLEXIGLAS® from Evonik Performance Materials GmbH.

The polyalkyl(meth)acrylates can be produced by polymerization processes, and particular preference is given here to free-radical polymerization processes, in particular bulk polymerization, solution polymerization, suspension polymerization and emulsion polymerization processes. Initiators particularly suitable for these purposes encompass in particular azo compounds, such as 2,2′-azobis(isobutyronitrile) or 2,2′-azobis(2,4-dimethylvaleronitrile), redox systems, e.g. the combination of tertiary amines with peroxides or sodium disulphite and persulphates of potassium, sodium or ammonium, or preferably peroxides (in which connection cf for example H. Rauch-Puntigam, Th. Völker, “Acryl-and Methacrylverbindungen” [Acrylic and methacrylic compounds], Springer, Heidelberg, 1967, or Kirk-Othmer, Encyclopedia of Chemical Technology, Vol. 1, pages 386 ff, J. Wiley, New York, 1978). Examples of particularly suitable peroxide polymerization initiators are dilauroyl peroxide, tert-butyl peroctoate, tert-butyl perisononanoate, dicyclohexyl peroxodicarbonate, dibenzoyl peroxide and 2,2-bis(tert-butylperoxy)butane. It is also possible and preferred to carry out the polymerization reaction using a mixture of various polymerization initiators of different half-lifetime, examples being dilauroyl peroxide and 2,2-bis(tert-butylperoxy)butane, in order to maintain a constant stream of free radicals during the course of the polymerization reaction, and also at various polymerization temperatures. The amounts used of polymerization initiator are generally from 0.01 wt.-% to 2.0 wt.-%, based on the monomer mixture.

The polymerization reaction can be carried out continuously or else batchwise. After the polymerization reaction, the polymer is obtained by way of conventional steps of isolation and separation, e.g. filtration, coagulation and spray drying.

The chain lengths of the polymers or copolymers can be adjusted by polymerizing the monomer or monomer mixture in the presence of molecular-weight regulators, a particular example being the mercaptans known for this purpose, e.g. n-butyl mercaptan, n-dodecyl mercaptan, 2-mercaptoethanol or 2-ethylhexyl thioglycolate, pentaerythritol tetrathioglycolate; the amounts used of the molecular-weight regulators generally being from 0.05 wt.-% to 5.0 wt.-%, preferably from 0.1 wt.-% to 2.0 wt.-% and particularly preferably from 0.2 wt.-% to 1.0 wt.-%, based on the monomer or monomer mixture (cf. H. Rauch-Puntigam, Th. Völker, “Acryl-and Methacrylverbindungen” [Acrylic and methacrylic compounds], Springer, Heidelberg, 1967; Houben-Weyl, Methoden der organischen Chemie [Methods of organic chemistry], Vol. XIV/1, page 66, Georg Thieme, Heidelberg, 1961, or Kirk-Othmer, Encyclopedia of Chemical Technology, Vol. 1, pages 296 ff, J. Wiley, New York, 1978). n-Dodecyl mercaptan is particularly preferably used as a molecular-weight regulator.

Preferably, the polyalkyl(meth)acrylate for use in the present invention is not cross-linked.

In a further embodiment the optical element may comprise poly(meth)acrylalkylimide. The structure of poly(meth)acrylalkylimide may be represented by repeating units of the following Formula (II):

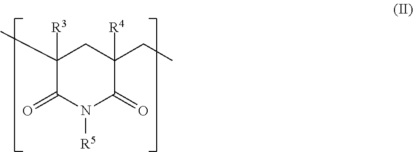

in which the moieties R³ and R⁴ are independently a hydrogen atom or a methyl group and R⁵ is an alkyl group having from 1 to 20, preferably 1 to 10 carbon atoms. In a particularly preferred embodiment, the moieties R³, R⁴ and R⁵ are methyl groups.

The monomeric units of Formula (II) preferably form more than 30 wt.-%, particularly preferably more than 50 wt.-% and very particularly preferably more than 80 wt.-% of the poly(meth)-acrylalkylimide. Typically, a poly(meth)acrylalkylimide molecule comprises from 60 to 6 000, more preferably from 100 to 2 000 of monomeric units represented by Formula (II).

Preparation of poly(meth)acrylalkylimides is known and is disclosed, for example, in GB 1 078 425, GB 1 045 229, DE 1 817 156 or DE 27 26 259. Poly(meth)acrylalkylimides are commercially available from Evonik Performance Materials GmbH under the trademark PLEXIMID®.

In addition, poly(meth)acrylalkylimides may contain further repeating units which arise, for example, from esters of acrylic or methacrylic acid, in particular with lower alcohols having 1-4 carbon atoms, styrene, maleic acid or the anhydride thereof, itaconic acid or the anhydride thereof, vinylpyrrolidone, vinyl chloride or vinylidene chloride. The proportion of the comonomers, which cannot be cyclized or can be cyclized only with very great difficulty, should not exceed 30 wt.-%, preferably 20 wt.-% and particularly preferably 10 wt.-%, based on the weight of the monomers.

The materials of the optical element are preferably those which comprise poly(N-methylmethacrylimides) (PMMI) and/or polymethyl methacrylates (PMMA). Poly(N-methylmethacrylimides) (PMMI), polymethyl methacrylates (PMMA) and/or PMMI-PMMA copolymers are preferably copolymers of PMMI and PMMA which are prepared by partial cycloimidization of PMMA. PMMI which is prepared by partial imidization of PMMA is usually prepared in such a way that not more than 83 wt.-% of the PMMA used are imidized. The resulting product is referred to as PMMI but strictly speaking is a PMMI-PMMA copolymer. Both PMMA and PMMI or PMMI-PMMA copolymers are commercially available, for example under the brand name PLEXIMID® from Evonik Röhm GmbH. The products and their preparation are known (Hans R. Kricheldorf, Handbook of Polymer Synthesis, Part A, published by Marcel Dekker Inc. New York-Basel-Hong Kong, page 223 et seq.; H. G. Elias, Makromoleküle [Macromolecules], published by Hüthig and Wepf Basel-Heidelberg-New York; U.S. Pat. Nos. 2,146,209 and 4,246,374).

The moulding composition comprises at least one compound of general Formula (I)

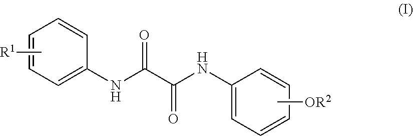

in which the moieties R¹ and R² are independently an alkyl or cycloalkyl groups having from 1 to 10 carbon atoms, preferably from 1 to 4 carbon atoms, particularly preferably 2 carbon atoms.

Among the preferred alkyl groups are the methyl, ethyl, propyl, isopropyl, 1-butyl, 2-butyl, 2-methylpropyl, tert-butyl, pentyl, 2-methylbutyl, 1,1-dimethylpropyl, hexyl, heptyl, octyl, 1,1,3,3-tetramethylbutyl, nonyl, 1-decyl and 2-decyl group. Among the preferred cycloalkyl groups are the cyclopropyl, cyclobutyl, cyclopentyl, cyclohexyl, cycloheptyl and cyclooctyl group, which optionally have branched or unbranched alkyl groups as substituents.

Preference is given to use of the compound of the Formula (IV)

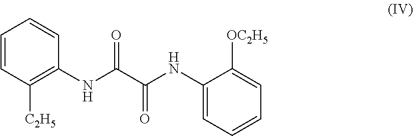 [SMILES: CCOc1ccccc1NC(=O)C(=O)Nc1ccccc1CC]

This compound is commercially available from the BASF SE (Ludwigshafen, Germany) as Tinuvin® 312.

The inventors further found that an optimal compromise between high weathering resistance and high transparency in the visible region is achieved when the moulding composition comprises from 0.0005 wt.-% to 0.5 wt.-% of the compound of Formula (I), based on the weight of the moulding composition. Preferably, the composition comprises between 0.001 wt.-% to 0.1 wt.-% of the compound of Formula (I), more preferably between 0.01 wt.-% to 0.1 wt.-%, for instance between 0.05 wt.-% to 0.1 wt.-%.

As already mentioned above, the composition used in the light emitting element of the present invention has an excellent inherent thermal stability. Therefore, it may comprise less than 2 wt.-% of thermal stabilisers, preferably less than 0.1 wt.-%, more preferably less than 0.001 wt.-% and even more preferably less than 0.0001 wt.-%, based on the weight of the moulding composition. The term “thermal stabilizer” as used herein refers to compounds added to PMMA-based moulding compounds for increasing their stability against thermal degradation. Thermal stabilisers as such are known to the skilled person and are described inter alia in the Kunststoff-Handbuch, Bd. IX, S. 398, Carl-Hanser-Verlag, 1975 and in patent literature e.g. in DE 10 335 578 A1.

Examples of commonly used thermal stabilisers mentioned above include but are not limited to p-methoxyphenylethacrylamide, diphenylmethacrylamide, sodium dodecyl phosphate, disodium monooctadecyl phosphate, disodium mono(3,6-dioxyoctadecyl)phosphate and alkylamino salts of mono- and dialkyl-substituted phosphoric acids described in DE 10 335 578 A1.

Since the material of the light guide unit has an excellent thermal stability, the light emitting element of the present invention may comprise a high-power light source such as high-power LED. The maximal operating temperature on the surface of the light source may be as high as 50° C., preferably at least 60° C., even more preferably at least 70° C., or even 80° C. or even higher. Depending on the properties of the moulding composition unit it is, nevertheless, desired that maximal operating temperature on the surface of the light source does not exceed 150° C., or does not exceed 130° C., or does not exceed 110° C.

The moulding composition may further comprise at least one compound of Formula (III):

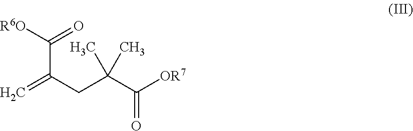

in which the moieties R⁶ and R⁷ are independently an alkyl or a cycloalkyl moiety having from 1 to 10 carbon atoms. Typically, R⁶ and R⁷ are identical alkyl moieties having from 1 to 4 carbon atoms.

The compound of Formula (III) is usually represented by the following structure (IIIa):

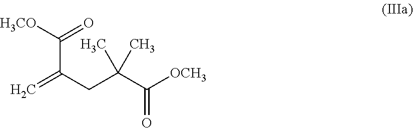

The inventors investigated the effect of the presence of the compound of Formula (III) in the moulding composition and surprisingly found that an optimal combination of appropriate mechanical properties and high weathering resistance can be achieved when the composition comprises from 0.01 wt.-% to 0.5 wt.-%, more preferably from 0.05 wt.-% to 0.2 wt.-% of the compound of Formula (III), based on the weight of the moulding composition. For instance, the composition may comprise 0.1 wt.-% or 0.07 wt.-% of the compound of Formula (III). Presence of more than 1.0 wt.-% of the compound of Formula (III) in the moulding composition may lead to formation of cracks and crazes during operation of the light emitting element. Accordingly, during the manufacturing of the light guide unit it is advantageous that the content of the compound of Formula (III) is kept within the above range.

The moulding composition may further comprise at least one sterically hindered amine, giving a further improvement in weathering resistance, in particular upon a long-term exposure to outdoor conditions. Particularly preferred sterically hindered amines include dimethyl succinate-1-(2-hydroxyethyl)-4-hydroxy-2,2,6,6-tetramethylpiperazine polycondensate, poly[{6-(1,1,3,3-tetramethylbutyl)amino-1,3,5-triazine-2,4-diyl}{(2.2,6,6-tetramethyl-4-piperidyl)imino}hexamethylene{(2,2,6,6-tetramethyl-4-piperidyl)imino}], N,N′-bis(3-aminopropyl)ethylenediamine-2,4-bis[N-butyl-N-(1,2,2,6,6-pentamethyl-4-piperidyl)amino]-6-chloro-1,3,5-triazine condensate, bis(2,2,6,6-tetramethyl-4-piperidyl) sebacate and bis(1,2,2,6,6-pentamethyl-4-piperidyl) 2-(3,5-di-tert-4-hydroxybenzyl)-2-n-butylmalonate.

In one embodiment, moulding composition may further comprise scattering particles, which may be uniformly distributed within the matrix of the substantially light transmitting polymeric material such as PMMA, silicones or cross-linked polystyrene. For instance, the scattering particles may be polymeric particles having a size of at least 7 μm. Such particles are usually present in an amount ranging from 0.01 wt % to 1 wt %, based on the weight of the moulding composition. Use of the corresponding particles is described inter alia in EP 656 548, the entire disclosure of which is incorporated herein by reference.

In a further embodiment, the moulding composition may comprise uniformly distributed barium sulphate particles with an average particle size of from 0.3 to 20 μm as scattering particles in a concentration of from 0.001 wt % to 0.08 wt %, based on the weight of the moulding composition. Use of the corresponding particles is described in EP 1 453 900.

In yet a further embodiment, the light guide unit can comprise titanium dioxide particles with an average particle size of from 150 to 500 nm in a concentration of from 0.00001 to 0.01 wt-%, based on the weight of the moulding composition. To ensure, that the light guide unit has a high weathering resistance, the titanium dioxide particles should ideally have a proportion of the rutile modification of at least 50 wt %, preferably at least 60 wt %, particularly preferably at least 70 wt % and more particularly at least 90 wt %, based on the total weight of titanium dioxide particles.

Typically, the light guide unit in the light emitting element of the present invention is practically colourless. The yellowness index (Y.I.) of the light guide unit is typically below 1.5, preferably below 1, measured according to ISO 17223:2014 (CIE standard illumination D65, 1964 supplementary standard observer) or according to ASTM D 1925, wherein the thickness of the specimen is 3.2 mm. Such a low yellowness index is attained without any addition of blueing agents. If blueing agents are added during compounding, a yellowness index below 0.5, preferably below 0.3 can be attained. The term “yellowness index” is well-known to a skilled person and describes the yellowing of a material upon degradation caused by e.g. temperature, humidity or UV radiation.

The light guide unit in the light emitting element of the present invention is characterized by high weathering resistance and stability of the optical quality under the effect of moisture. Weathering resistance tests can be performed in line with the norm ISO 4892-2. For instance, an accelerated laboratory weathering test following to the norm DIN EN ISO 4892-2 can be carried out under the following conditions:

| | | |
|---|---|---|
| total exposure time: | 10 000 | h |
| radiant exposure: | 6.48 | GJ/m² |
| irradiance: | 180 | W/m² |

After a test under these conditions, the yellowness index Y.I. as defined in the norm ISO 17223:2014 (CIE standard illumination D65, 1964 supplementary standard observer) is not higher than 5.0, preferably not higher than 3.0, wherein the thickness of the specimen is 3.2 mm.

An example of an accelerated laboratory weathering test employing relatively hot and dry conditions is a so-called “Arizona”-test. The test parameters are as follows:
Xenon Arc Lamp Instrument: ATLAS Xenotest Alpha+
Filter: Xenochrome 300 filter system, daylight (ISO 4892-2)
Irradiance: 180 W/m² (300-400 nm), no dark cycle
Radiant exposure after 1000 h: 0.648 GJ/m² (300-400 nm)
Temperatures: chamber 50° C., black standard 83° C.
Humidity: 15% RH (obtained by switching off the RH control)
Spray: 6 min every 2 h

An example of an accelerated laboratory weathering test employing humid conditions is a so-called “Florida”-test. This test is carried out under the following conditions:
Xenon Arc Lamp Instrument: ATLAS Xenotest Alpha+
Filter: Xenochrome 300 filter system, daylight (ISO 4892-2)
Irradiance: 180 W/m² (300-400 nm), no dark cycle
Radiant exposure after 1000 h: 0.648 GJ/m² (300-400 nm)
Temperatures: chamber 50° C., black standard 83° C.
Humidity: 70% RH
Spray: 30 min every 90 min

Overall, the average sample temperature in the “Florida” test is significantly lower when compared to the “Arizona” test. This can be attributed to significantly longer water spray times in the Florida test, where the chamber and thus sample temperature is not controlled and closer to room temperature, rather than 50° C. In both tests, the term “radiant exposure” refers to UV broadband values, measured from 300 to 400 nm. Testing is stopped after 10 000 h which corresponds to a radiant exposure of 6.48 GJ/m².

The yellowness index of the light guide unit during the tests preferably remains below 5.0, more preferably below 4.0, even more preferably below 3.0 and particularly preferably below 2.0, wherein the thickness of the specimen is 3.2 mm.

Typically, during and after the accelerated laboratory weathering tests described above the detectable increase in haze is not higher than 3.0, preferably not higher than 2.0, particularly preferably not higher than 1.0, wherein the thickness of the specimen is 3.2 mm. In a particularly preferred embodiment, the haze of the light guide unit during and after the accelerated laboratory weathering test is not higher than 0.5, compared to the initial haze of the light guide unit. The haze can be measured according to the norm ASTM D1003 using a sample with a thickness of 3.2 mm.

The light guide unit of the present invention can be advantageously used for the manufacturing of an outdoor light emitting device. The outdoor light emitting device comprises at least one light emitting element as described above. The outdoor light emitting device may further comprise optical elements such as reflectors to reflect light of the light emitting element and lenses allowing focusing light of the light emitting elements, if desired. In some embodiments, the outdoor light emitting device may also comprise a power supply unit or a battery. Furthermore, the outdoor light emitting device may comprise an electrical engine to allow a precise positioning of the light emitting element or to focus its light.

The light emitting device of the present invention is suitable for use in a wide range of outdoor applications such as backlighting in traffic signs, street lights, advertising panels, outdoor illumination means or in exterior vehicle lighting. Since the light guide unit has a particularly low increase of the yellowness index under typical outdoor conditions and has a high thermal stability the light emitting device is highly suitable for a long-term use in a wide range of climatic conditions including deserts and humid and warm areas.

The following examples illustrate the invention in a greater detail. However, there is no intention that the present invention be restricted to these examples.

### EXAMPLES

### Optical Transmittance

Optical transmittance properties of PMMA comprising UV absorbers at short light paths were investigated using Sample 1 and Sample 2.

A Varian Cary 5000 spectrophotometer was used to measure direct and total spectral transmittance, along with Y.I. according to ISO 17223 for CIE standard illuminant D65 and colour system X₁₀Y₁₀Z₁₀.

Sample 1 (Comparative).

A 3.2 mm thick specimen plate was prepared from PMMA comprising ca. 96 wt.-% methylmethacrylate and ca. 4 wt. % methylacrylate and having a weight average molecular weight Mw of ca. 150 000 g/mol with 100 ppm of Tinuvin® P (2-(2H-benzotriazol-2-yl)-p-cresol, benzotriazol-type UV absorber, commercially available from the BASF SE).

Sample 2.

A further 3.9 mm thick specimen plate was prepared from PMMA comprising ca. 99 wt.-% methylmethacrylate and ca. 1 wt. % methylacrylate and having a weight average molecular weight Mw of ca. 100 000 g/mol with 800 ppm of Tinuvin® 312 (oxanilide-type UV absorber, commercially available from the BASF SE).

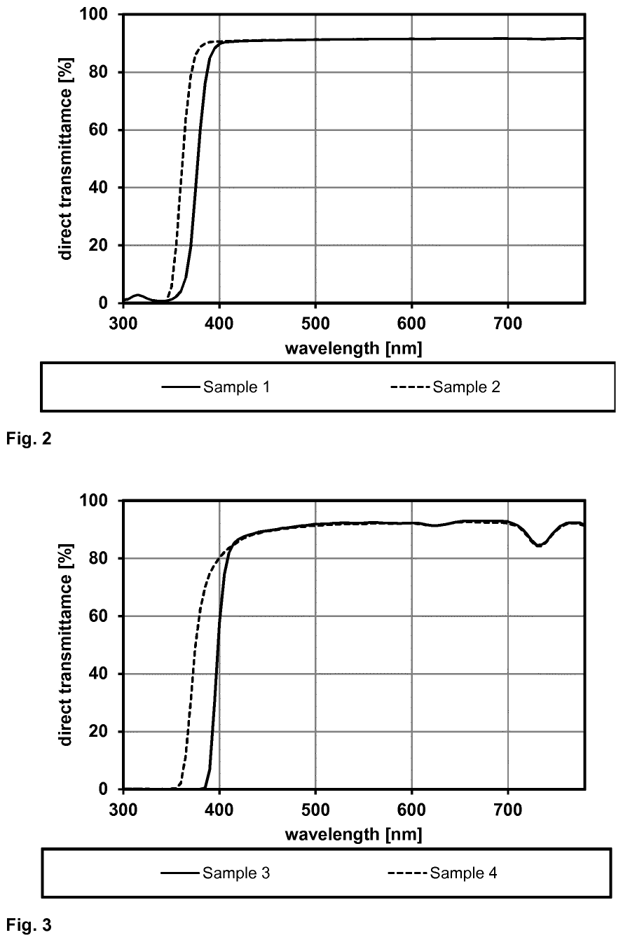

The optical transmittance measurements were carried out on both plates in the range between 300 nm and 800 nm. The results of the measurements are shown in FIG. 2.

Although the content of the oxanilide-type UV absorber Tinuvin® 312 in Sample 2 was 8 times as high as the content of the benzotriazol-type UV absorber Tinuvin® P in Sample 1, the Sample 2 showed a significantly better transmittance in near UV range.

Additionally, light-guiding properties of PMMA comprising UV absorbers were investigated using Sample 3 and Sample 4.

Sample 3 (Comparative).

A 145 mm long specimen bar was prepared from PMMA comprising ca. 99 wt.-% methylmethacrylate and ca. 1 wt. % methylacrylate and having a weight average molecular weight Mw of ca. 100 000 g/mol with 100 ppm of Tinuvin® P.

Sample 4.

A further 145 mm long specimen bar plate was prepared from PMMA comprising ca. 99 wt.-% methylmethacrylate and ca. 1 wt. % methylacrylate and having a weight average molecular weight Mw of ca. 100 000 g/mol with 100 ppm of Tinuvin® 312.

The light-guiding properties of Sample 3 and Sample 4 in the range between 300 nm and 800 nm were measured. The results of the measurements are shown in FIG. 3. The calculated yellowness index of the Samples 3 and 4 was 3.14 and 3.11, respectively.

FIG. 3 reveals that at a relatively long light path the benzotriazole-type UV absorber Tinuvin® P has a noticeable absorption of visible blue light. Accordingly, if PMMA comprising Tinuvin® P is used as a light guide unit in combination with a white light source, the emitted light would appear yellowish, wherein the undesired yellow colour would increase with increasing distance from the light source.

All samples contained 0.05 wt.-% to 0.2 wt.-%, of the compound of Formula (IIIa), based on the weight of the moulding composition.

### Stability Testing

To study the aging behaviour of PMMA materials stabilized with different UV absorbers, Samples 1 and 2 described above and Sample 5 were employed.

Sample 5 (Comparative).

A 3.3 mm thick specimen plate was prepared from PMMA comprising ca. 99 wt.-% methylmethacrylate and ca. 1 wt. % methylacrylate and having a weight average molecular weight Mw of ca. 150 000 g/mol with 100 ppm of Tinuvin® P (benzotriazol-type UV Absorber, commercially available from the BASF SE).

The Samples 1, 2 and 5 were subjected to accelerated laboratory weathering with a xenon arc instrument.

Hot and dry “Arizona” conditions were simulated with the following parameters:
Xenon Arc Lamp Instrument: ATLAS Xenotest Alpha+
Filter: Xenochrome 300 filter system, daylight (ISO 4892-2)
Irradiance: 180 W/m² (300-400 nm), no dark cycle
Radiant exposure after 1000 h: 0.648 GJ/m² (300-400 nm)
Temperatures: chamber 50° C., black standard 83° C.
Humidity: 15% RH (obtained by switching off the RH control)
Spray: 6 min every 2 h

Humid “Florida” conditions were simulated with the following parameters:
Xenon Arc Lamp Instrument: ATLAS Xenotest Alpha+
Filter: Xenochrome 300 filter system, daylight (ISO 4892-2)
Irradiance: 180 W/m² (300-400 nm), no dark cycle
Radiant exposure after 1000 h: 0.648 GJ/m² (300-400 nm)
Temperatures: chamber 50° C., black standard 83° C.
Humidity: 70% RH
Spray: 30 min every 90 min

The radiant exposure refers to UV broadband values, measured from 300 to 400 nm. Testing was stopped after 10 000 h which corresponds to a radiant exposure of 6.48 GJ/m².

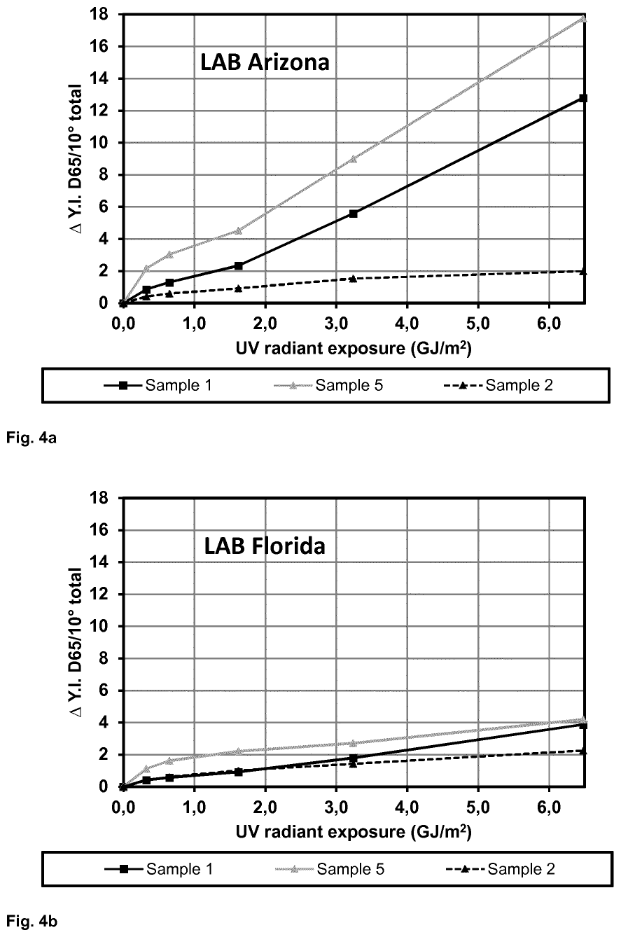

The Y.I. development under Arizona conditions is shown in FIG. 4A and the Y.I. development under Florida conditions is illustrated by FIG. 4B. The yellowness index Y.I. is a good indicator for the yellowing of a material upon degradation caused by e.g. temperature, humidity and/or UV light.

There is a surprising difference in the degradation behaviour of samples stabilized with the benzotriazole-type UV absorber Tinuvin® P and oxanilide-type UV absorber Tinuvin® 312. The increase in Y.I. in the (cooler) Florida test correlates well with radiant exposure and there is only little difference in degradation, which may be attributed to the different concentrations of the used UV absorbers. The hotter Arizona test shows that the benzotriazole-type absorber Tinuvin® P is significantly more sensitive to the increased (effective) temperature than the oxanilide-type UV absorber Tinuvin® 312.

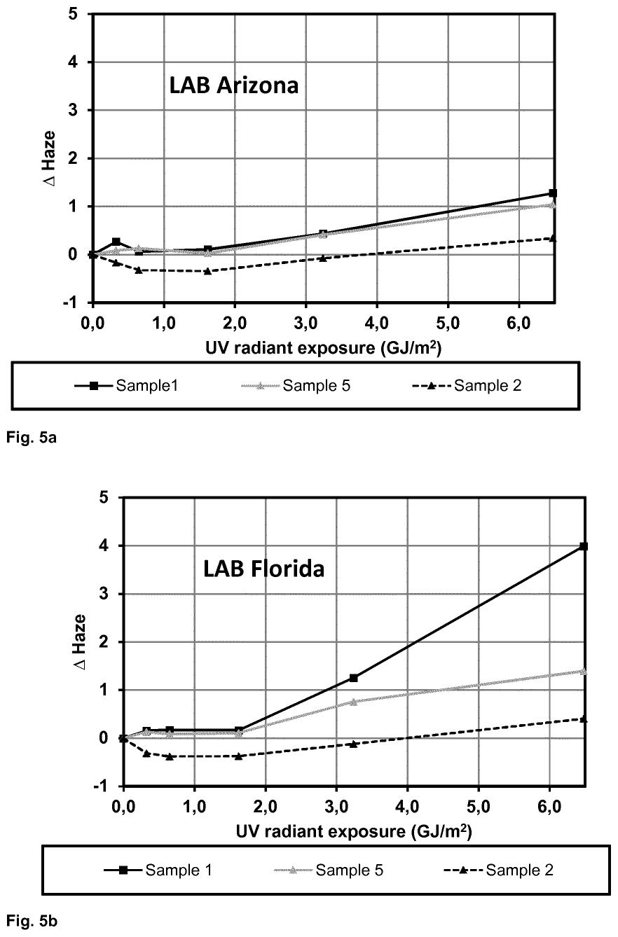

The development of haze during the tests is shown in FIGS. 5A and 5B. Again, the sample with the oxanilide-type UV absorber Tinuvin® 312 showed a lower decrease than the samples comprising benzotriazole-type UV absorber Tinuvin® P.

This indicates that the material comprising the oxanilide-type UV absorber has a better suitability for a long-term outdoor use.

In particular, the data show that a benzotriazole-type UV absorber such as Tinuvin® P can only be used in relatively low amounts (100 ppm) so that the undesired yellow tint at a high optical path can be avoided. However, such UV absorber does not impair the transparent material such as PMMA with a sufficient weathering resistance in such low amounts.

In contrast, an oxanilide-type UV absorber such as Tinuvin® 312 can be used in significantly higher quantities (800 ppm) without causing the undesirable yellow tint being visible in the emitted light at a high optical path. As a consequence, the resulting moulding compound has an excellent weathering resistance and can be advantageously used as an edge-lit light guide unit in outdoor applications.

1. A light emitting element, comprising:
a light guide unit having at least one edge and at least one surface; and
at least one light source arranged on the at least one edge of the light guide unit,
wherein the at least one surface of the light guide unit is directly exposed to an environment of the light emitting element, and
wherein the light guide unit comprises
a moulding composition, comprising
a substantially light transmitting polymeric material; and
at least one compound of Formula (I) 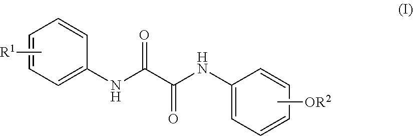
in which moieties R¹ and R² are independently an alkyl or cycloalkyl moiety having from 1 to 10 carbon atoms.

2. The light emitting element according to claim 1, wherein the substantially light transmitting polymeric material is selected from the group consisting of polyalkyl(eth)acrylate, poly(meth)acrylmethylimide, polycarbonate, polystyrene, polyethylene terephthalate, polyethylene, polypropylene, a styrene-copolymer, a cycloolefin, a cycloolefin-copolymer, and a mixture thereof.

3. The light emitting element according to claim 2, wherein the substantially light transmitting polymeric material is the polyalkyl(meth)acrylate, and wherein the polyalkyl(meth)acrylate is a copolymer comprising
from 80 wt.-% to 99 wt.-% of methyl methacrylate units, and
from 1 wt.-% to 20 wt.-% of C₁-C₁₀-alkyl acrylate units,
based on the weight of the copolymer.

4. The light emitting element according to claim 2, wherein the substantially light transmitting polymeric material is the polyalkyl(meth)acrylate which comprises
methyl methacrylate units, and
methyl acrylate units and/or ethyl acrylate units.

5. The light emitting element according to claim 2, wherein the substantially light transmitting polymeric material is the poly(meth)acrylmethylimide which comprises repeating units of Formula (II) 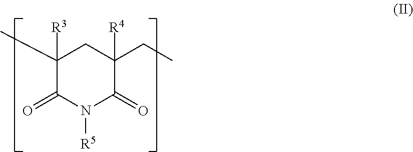
in which moieties R³ and R⁴ are independently a hydrogen atom or a methyl group, and R⁵ is an alkyl moiety having from 1 to 20 carbon atoms.

6. The light emitting element according to claim 1, wherein the at least one compound according to Formula (I) is represented by Formula (IV)

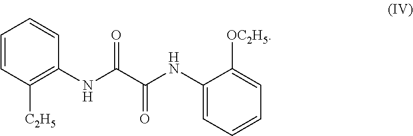 [SMILES: CCOc1ccccc1NC(=O)C(=O)Nc1ccccc1CC]

7. The light emitting element according to claim 1, wherein the moulding composition comprises
from 0.0005 wt.-% to 0.1 wt.-% of the at least one compound of Formula (I), based on the weight of the moulding composition.

8. The light emitting element according to claim 1, wherein the moulding composition comprises
less than 2 wt.-% of thermal stabilizers, based on the weight of the moulding composition.

9. The light emitting element according to claim 1, wherein a maximal operating temperature on a surface of the at least one light source is at least 50° C.

10. The light emitting element according to claim 1, wherein the moulding composition further comprises
at least one compound of Formula (III) 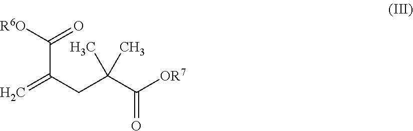
in which moieties R⁶ and R⁷ are independently an alkyl or a cycloalkyl moiety having from 1 to 10 carbon atoms.

11. The light emitting element according to claim 1, wherein the light guide unit has a yellowness index Y.I. as defined in the norm ISO 17223:2014 of not more than 5, wherein the thickness of the light guide unit is 3.2 mm, measured after an accelerated laboratory weathering test according to the norm DIN EN ISO 4892-2 under the following conditions:

| | | |
|---|---|---|
| total exposure time: | 10,000 | h, |
| radiant exposure: | 6.48 | GJ/m², and |
| irradiance: | 180 | W/m². |

12. The light emitting element according to claim 1, wherein the light guide unit comprises
scattering particles.

13. An outdoor light emitting device, comprising:
the light emitting element according to claim 1.

14. A method, comprising:
manufacturing an outdoor light emitting device with the light emitting element according to claim 1.

15. The outdoor light emitting device according to claim 13, wherein the outdoor light emitting device is a light source for backlighting in traffic signs, street lights, advertising panels, outdoor illumination, or in exterior vehicle lighting.

16. The light emitting element according to claim 5, wherein in the repeating units of Formula (II), R⁵ is an alkyl moiety having from 1 to 10 carbon atoms

17. The light emitting element according to claim 8, wherein moulding composition comprises
less than 0.0001 wt-% of the thermal stabilizers, based on the weight of the moulding composition.

18. The light emitting element according to claim 9, wherein the maximal operating temperature on the surface of the at least one light source is at least 60° C.

19. The light emitting element according to claim 10, wherein the moulding composition comprises
from 0.01 wt.-% to 0.5 wt.-% of the at least one compound of Formula (III), based on the weight of the moulding composition).

20. The light emitting element according to claim 11, wherein the light guide unit has the yellowness index Y.I. of not more than 3.
